(19) United States
(12) Patent Application Publication
(10) Pub. No.: US 2010/0127579 A1
(43) Pub. Date: May 27, 2010

(54) Magnetically levitated transport system

(76) Inventor: Dumitru Bojiuc, Dana Point, CA (US)

Correspondence Address: PATENT LAW & VENTURE GROUP, 2424 S.E. BRISTOL, SUITE 300, NEWPORT BEACH, CA, 92660, US

(21) Appl. No.: 11/209,916

(22) Filed: Aug. 22, 2005

Related U.S. Application Data
(63) Continuation-in-part of application No. 11/200,920, filed on Aug. 9, 2005, now abandoned.
(60) Provisional application No. 60/603,444, filed on Aug. 20, 2004.

(51) Int. Cl. H02K 41/02; B60L 13/00

(52) U.S. Cl. 310/12.22; 310/12.09

(57) ABSTRACT

A DC linear electric motor-generator has located at each edge of a curved triangular shaped linear ferromagnetic core, electro-magnets or solenoids interconnected in series or parallel as determined by user objectives, with each main solenoid coil hosted by each segment of the ferromagnetic core.

### RELATED APPLICATIONS

This application claims international priority from a prior filed U.S. Provisional Patent Application having Ser. No. 60/603,444 filed with the United States Patent Office on Aug. 20, 2004 and which is copending with this present non-provisional application. U.S. 60/603,444 is hereby incorporated herein by reference. This application is a Continuation-In-Part application of a prior filed U.S. Utility patent application having Ser. No. 11/200,920 and entitled “Monopole Field Electric Motor Generator” filed on Aug. 9, 2005.

### BACKGROUND

1. Field of the Present Disclosure

This disclosure relates generally to electric motor-generators and more particularly to a DC linear electromagnetic machine operating by electrical induction.

2. Description of Related Art

The following art defines the present state of the field of the apparatus described and claimed herein:

Tu et al, US 2004/0135452, discloses a flat rotary electric generator that includes at least one toroidal coil structure for cutting magnetic lines to induce a current and at least one disc-shaped magnetic pole structure oriented parallel to the helical coil structure. If multiple toroidal coil structures and disc-shaped magnetic coil structures are included, the toroidal coil structures and disc-shaped magnetic coil structures are arranged in alternating manner. The toroidal coil structure and disc-shaped magnetic pole structure are not provided with a permeable material. When either the toroidal coil structures or the at least one disc-shaped magnetic pole structure is rotated by an external force, the toroidal coil structure cuts the magnetic lines passing therethrough to generate an induced current. Neal, US 2002/0135263, discloses a plurality of stator arc segments that form a toroidal core for a stator assembly used to make a motor. In a preferred embodiment, a plurality of magnetic fields is created when electrical current is conducted through wire wound around poles on the toroidal core. A monolithic body of phase change material substantially encapsulates the conductors and holds the stator arc segments in contact with each other in the toroidal core. Hard disc drives using the motor, and methods of constructing the motor and hard disc drives are also disclosed. Rose, U.S. Pat. No. 6,803,691, discloses an electrical machine that comprises a magnetically permeable ring-shaped core centered on an axis of rotation and having two axially-opposite sides. Coils are wound toroidally about the core and disposed sequentially along the circumferential direction. Each coil includes two side legs extending radially alongside respectively sides of the core. Coil-free spaces exist between adjacent side legs. A bracket has first and second side flanges that are connected by a bridging structure and respectively abut the first and second sides of the coil. Mohler, U.S. Pat. No. 6,507,257, discloses a bi-directional latching actuator that is comprised of an output shaft with one or more rotors fixedly mounted thereon. The shaft and rotor are mounted for rotation in a magnetically conductive housing having a cylindrical coil mounted therein and is closed by conductive end caps. The end caps have stator pole pieces mounted thereon. In one embodiment, the rotor has at least two oppositely magnetized permanent magnets which are asymmetrically mounted, i.e., they are adjacent at one side and separated by a non-magnetic void on the other side. The stator pole piece has asymmetric flux conductivity and in one embodiment is axially thicker than the remaining portion of the pole piece. An abutment prevents the rotor from swinging to the neutral position (where the rotor magnets are axially aligned with the higher conductivity portion of the pole piece). Thus, the rotor is magnetically latched in one of two positions being drawn towards the neutral position. Energization of the coil with an opposite polarity current causes the rotor to rotate towards its opposite latching position whereupon it is magnetically latched in that position. Mohler, U.S. Pat. No. 5,337,030, discloses a permanent magnet brushless torque actuator that is comprised of an electromagnetic core capable of generating an elongated toroidally shaped magnet flux field when energized. Outside the generally cylindrical coil is an outer housing with upper and lower end plates at each end. Mounted to the end plates and extending towards each other are stator pole pieces separated from its opposing pole piece by an air gap. A permanent magnet rotor is disposed in the air gap and mounted on a shaft which in turn is rotatably mounted in each of the end plates. The permanent magnet rotor comprises at least two permanent magnets, each covering an arcuate portion of the rotor and having opposite polarities. Energization of the coil with current in one direction magnetizes the pole pieces such that each of the two pole pieces attracts one of the magnets of the rotor and repels the other magnet of the rotor resulting in a torque generated by the output shaft. Reversal of the current flow results in a reversal of the torque and rotation of the rotor in the opposite direction. Preferred embodiments are disclosed having multiple cells, i.e. a plurality of stator rotor stator combinations and/or cells in which there are a plurality of pole pieces at each stator pole plane. Kloosterhouse et al, U.S. Pat. No. 5,191,255, discloses an electromagnetic motor that includes a rotor having a plurality of magnets mounted along a perimeter of the rotor. Preferably, adjacent magnets have opposite poles facing outward. One or more electromagnets are disposed adjacent to the perimeter of the rotor so that as the rotor rotates, the magnets mounted on the rotor are carried near the poles of the electromagnets. Current is supplied to the electromagnets by a drive circuit in a predetermined phase relationship with the rotation of the rotor such that, for substantially all angular positions of the rotor, magnetic attraction and repulsion between the poles of the electromagnets and the magnets mounted on the rotor urge the rotor to rotate in a desired direction. Reflective material is mounted on the rotor in predetermined angular positions. The drive circuit includes a photosensitive device which produces a signal whose value varies according to whether the device is receiving light reflected from the reflective material. The signal is amplified to produce drive current for the electromagnets. Westley, U.S. Pat. No. 4,623,809, discloses a stepper motor housing a pole structure in which a pair of identical stator plates, each having a plurality of poles, are positioned back to back with the poles projecting in opposite directions, the stator plates being positioned between a pair of substantially identical stator cups, each stator cup having a plurality of poles projecting inwardly from a back wall with a peripheral side wall terminating in an outwardly extending flange. A major surface of each flange is in contact with a face on one of the stator plates so as to assure a low reluctance magnetic path. Fawzy, U.S. Pat. No. 4,565,938, discloses an electromechanical device which can be used as a motor or as a generator. The device has a housing, including bearing means to support a rotatable shaft. Disc magnet means are provided, and poled to have alternating polarity and are mounted on the shaft to define a rotor. The device includes at least one first pole shoe in contact with the magnet means, having a portion extending radially therefrom to define a virtual pole chamber, of a first polarity. Also included is at least one second pole shoe in contact with the magnet and having a portion extending radially therefrom to define a virtual pole chamber of the other polarity. A toroid stator is mounted on the housing and has windings thereon. The stator is positioned annularly around the disc magnets such that the virtual pole chambers of the first and second pole shoes surround portions of said windings with circumferentially alternating fields of alternating polarity. Means are provided for electrical contact with the stator to draw off current when the device is operated as a generator, or provide current to operate the device as a motor. Fawzy, U.S. Pat. No. 4,459,501, discloses an electromechanical device which can be used as a motor or as a generator that has a housing, including bearing means to support a rotatable shaft. A pair of disc magnets are poled to have opposite polarity on the two faces of each. The magnets are mounted face to face together on the shaft to define a rotor. The device includes at least one first pole shoe in contact with one face of each magnet, and having a portion extending radially therefrom to define, in its preferred form, a pair of virtual pole chambers, of the same polarity as said one face. Also included is at least one second pole shoe in contact with the other face of each magnet and having a portion extending radially therefrom to define in its preferred form a pair of virtual pole chambers of the same polarity as the other face. A toroidal stator is mounted on the housing and has windings thereon. The stator is positioned annularly around the disc magnets such that the virtual pole chambers of the first and second pole shoes surround portions of said windings with circumferentially alternating fields of alternating polarity. Means for electrical contact with the stator draw off current when the device is operated as a generator, or provide current to operate the device as a motor.

Our prior art search with abstracts described above teaches rotating electromagnet machines; in both motor and generator forms. Thus, the prior art shows in Neal, a toroidal core with radial arc segments, in Fawzy, we see a N-N and S-S pole face adjacency, in Tu et al, a N-S and S-N pole adjacency with radial coil windings, in Rose, we find radially wound coils in sequence around a toroidal core and with permanent magnet segments with N-N and S-S adjacency. However, the prior art fails to teach a linear electromagnetic machine that provides electromagnetic fields immersed in monopole permanent magnet fields of opposite polarities as is shown in the present apparatus and which provides operation by electrical induction.

The present disclosure distinguishes over the prior art providing heretofore unknown advantages as described in the following summary.

### SUMMARY

This disclosure teaches certain benefits in construction and use which give rise to the objectives described below.

A DC linear electric motor-generator has located at each edge of a curved triangular shaped linear ferromagnetic core, electro-magnets or solenoids interconnected in series or parallel as determined by user objectives, with each main solenoid coil hosted by each segment of the ferromagnetic core.

A primary objective inherent in the above described apparatus and method of use is to provide advantages not taught by the prior art.

Another objective is to provide an electromagnetic linear machine which develops a linear propulsive force while acting by induction.

A further objective is to provide such a machine useful as a transport.

A further objective is to provide such a machine capable of recovering electrical energy upon braking.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a vertical frontal cross-sectional schematic view of the present invention showing a transport system with a vehicle suspended from a support system and a means for propulsion shown above the vehicle;

FIG. 2 is a table of symbols used in the further figures;

FIG. 3 is a schematic diagram of a fixed, i.e., static portion of said propulsion system, an electromagnetic linear motor;

FIG. 4 is a schematic diagram of a moving or translational portion of said electromagnetic linear motor showing the vehicle engaged therewith; and

FIG. 5 is a schematic diagram; enlarged from FIG. 1; showing the principals and operating mechanisms of the present invention and clearly showing the interrelationship between the static and moving portions of the linear motor as well as an auto-balancing mechanism for the vehicle.

### LIST OF REFERENCE NUMERALS

140 linear-toroidal ferromagnetic core
141 linear ferromagnetic core
142 the stator assembly;
144 shaft
146 permanent magnet

a. 147 electromagnet or solenoid

b. 147-a electro-active-magnetic solenoid
148 the electric motor-generator solenoid's coil;
149 electromagnetic levitation & guidance solenoid
149-a electro-active-magnetic levitation & guidance pilot solenoid
150 the stator housing Al support on shaft
152 the stator's housing external Al ring support
153 the internal stator's permanent magnet Al support
154 the stator's permanent magnet ferromagnetic material support
156 the ferromagnetic core's Al support on shaft
158 commutator
160 cylindrical gaps
162 window or the cylindrical gap's aperture;
164 laminated ferromagnetic core
166 the solenoid's linear area or portion
168 UMD N or S symbol and its magnetic field influence
170 energy collector & inductor
172 pad
174 bearing
176 arched polygonal brush
178 the cylindrical commutator's split ring
179 the discoidal commutator's split ring
180 the tronconic commutator's slip ring
181 the cylindrical slip ring
182 the commutator's dielectric material
183 metallic collecting ring
184 the commutator's contactors
186 spring
188 the brushes support
190 the cockpit or load support & auto balance assembly
192 the inner stator's electro-active-magnetic rim
194 the external stator's electro-active-magnetic rim
196 the double ring counter rotated propeller

### DETAILED DESCRIPTION

The above described drawing figures illustrate the described apparatus and its method of use in at least one of its preferred, best mode embodiments, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

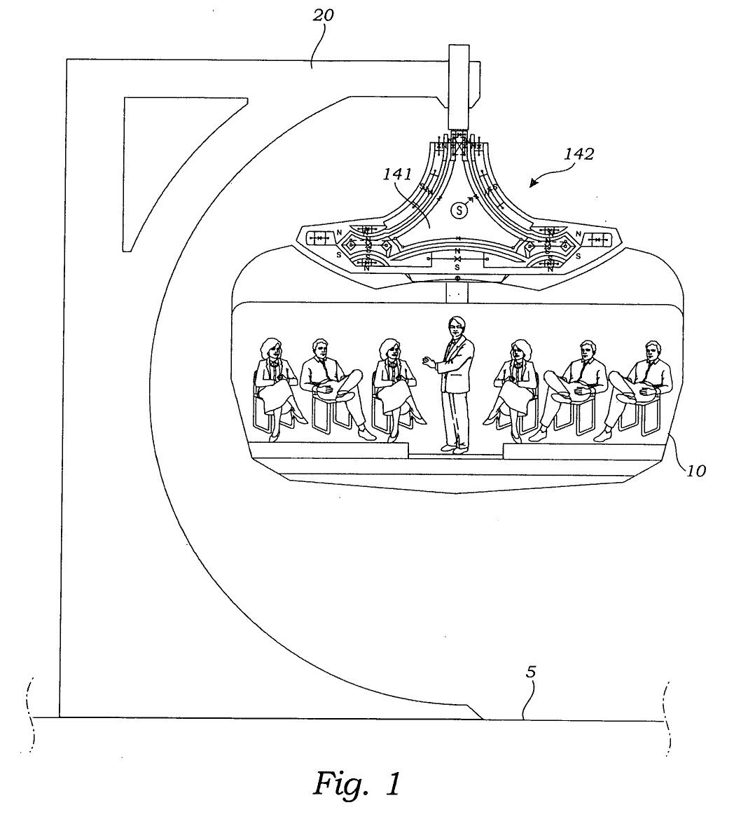

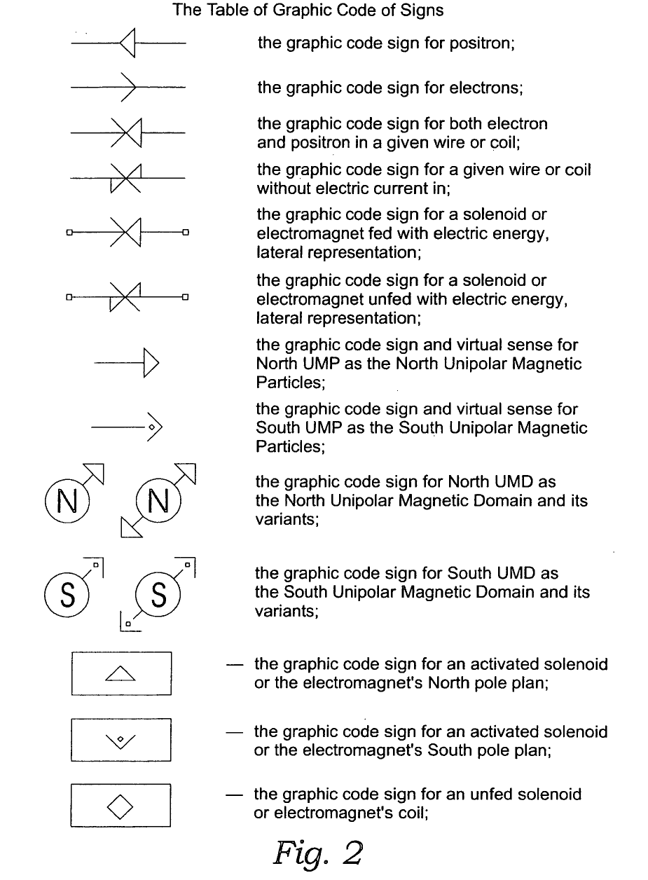

FIGS. 1-5 are views of an extension to the apparatus defined in U.S. application Ser. No. 11/200,920 of which the present application is a Continuation-In-Part and which operates under the same principle.

In contradistinction to the already recognized conceptual MAGLEV technologies in the prior art, the present application of electrodynamics and magnetism is highly distinct and may be shown to be fully practical and operational.

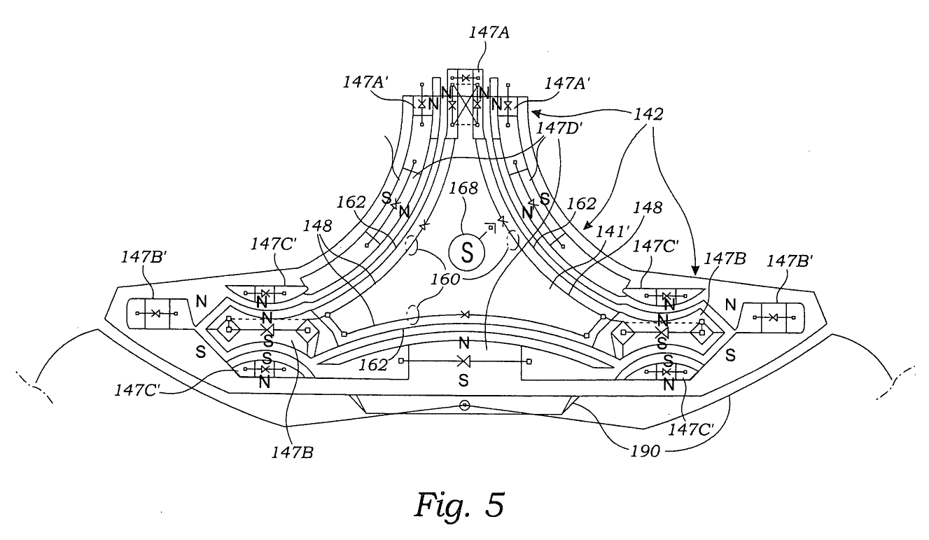

As shown in the figures, a train's cockpit is suspended under the rail system or guide way. However, the moving train may also be mounted above the guide way. FIG. 1 is a cross-sectional view of my conception and FIG. 5 is an enlarged portion of FIG. 1 showing the propulsion apparatus. As shown in the figures, the rail road is a linear ferromagnetic core which may be considered as the unfolded toroidal ferromagnetic core, i.e., the rotor defined in my previous copending application referenced herein.

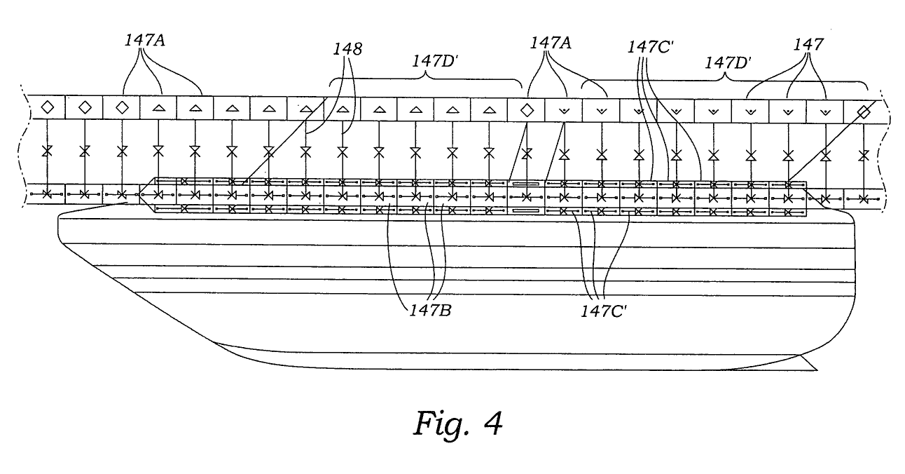

The present enablement is a DC linear electric motor-generator as shown in FIG. 4 wherein, located at each edge of the curved triangular shaped linear ferromagnetic core 141 and which actually are electro-magnets or solenoids 147 interconnected in series or parallel as will be determined by use objectives, with each main solenoid coil 148 hosted by each segment of the ferromagnetic core.

The linear ferromagnetic core's wiring system, as shown for each segment of this vertebral column is electrically interconnected in series and-or in parallel so that the coils end in a short cut interconnection and than a general protection switch where each of the coils has the same function, i.e., energy transfer, magnetic levitation, guidance and propulsion.

As shown in FIGS. 6 and 7 we see a part of the endless successive solenoids that comprise the rail road's linear ferromagnetic core and which represent a PMD until the UMP N & S of an external active magnetic source realigns its magnetic balance as shown. In FIG. 5 is shown the two main components of this propulsion system. First the fixed portion represented by the linear ferromagnetic core 141 having a cylindrical gap 160 ending toward its external surface in a window or the cylindrical gap's aperture 162 and holding-in the electric motor-generator solenoid's coil 148 connected in parallel with the electromagnet or solenoid 147 having the energy transformer & inductor 170 and electromagnetic levitation & guidance solenoid 149 as functional objective. Second, we show the mobile portion, represented by the stator assembly 142 with its electro-active-magnetic solenoid 147-a″ and incorporating in its functions both the electro-active-magnetic levitation & guidance pilot solenoid 149-a and the energy transformer & inductor 170 as shown. Additionally, the mobile portion provides the cockpit or load support & auto balance assembly 190 which sustains the load, i.e., passengers, freight and the like.

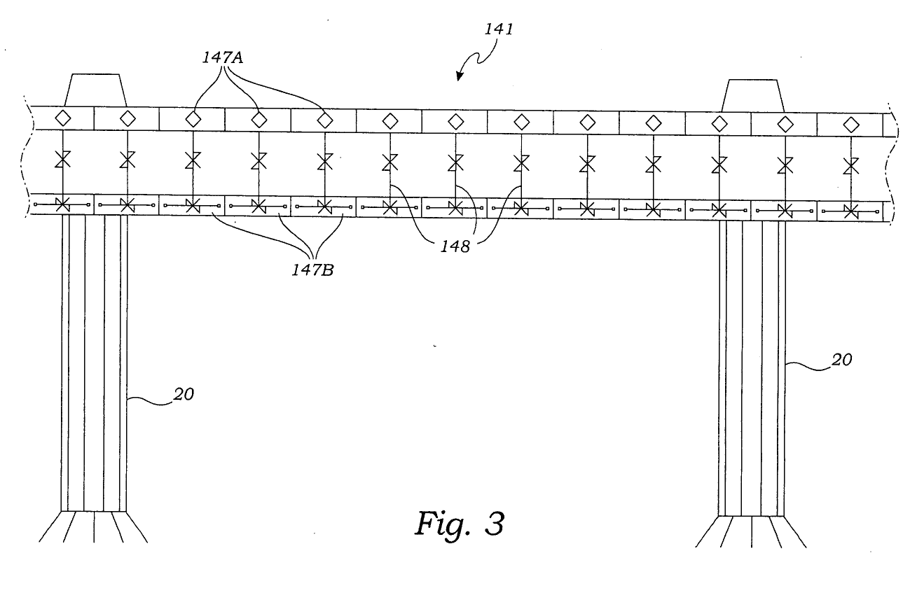

As shown in FIGS. 3 and 4, we see a part of the endless successive solenoids that comprise the rail road's linear ferromagnetic core and which represent a PMD until the UMP N & S of an external active magnetic source realigns its magnetic balance as shown. In FIG. 5 is shown the two main components of this propulsion system. First the fixed portion represented by the linear ferromagnetic core 141 having a cylindrical gap 160 ending toward its external surface in a window or the cylindrical gap's aperture 162 and holding-in the electric motor-generator solenoid's coil 148 connected in parallel with the electromagnet or solenoid 147 having the energy transformer & inductor 170 and electromagnetic levitation & guidance solenoid 149 as functional objective. Second, we show the mobile portion, represented by the stator assembly 142 with its electro-active-magnetic solenoid 147-a″ and incorporating in its functions both the electro-active-magnetic levitation & guidance pilot solenoid 149-a and the energy transformer & inductor 170 as shown. Additionally, the mobile portion provides the cockpit or load support & auto balance assembly 190 which sustains the load, i.e., passengers, freight and the like.

This linear electric motor-generator can use the electric energy from either an external source by direct feed to the rail road's solenoids or by inducing and controlling the necessary electric power. Levitation and guidance is provided by two electro-active-magnetic levitation & guidance pilot solenoids 149-a, surrounding the linear ferromagnetic core's electromagnetic levitation and guidance solenoids 149 as part of the linear electric motor-generator stator assembly. These two electro-active-magnetic solenoids are in fact electromagnets having the ferromagnetic core made up of permanent oriented magnets. When fed with PDC at a certain energy level, beside the energy from the permanent magnets, the electro-active-magnetic solenoids with their additional pulsating magnetic energy act as an inductor for the electromagnet or solenoid 147 and electromagnetic levitation & guidance solenoid 149 as part of the linear ferromagnetic core 141. The induced solenoids 147 and 149 create two effects. First, an opposed magnetic effect having an induced magnetic pole dominates each linear ferromagnetic core solenoid 147 & 149 keeping the inducers 147-a & 149-a at a desired distance by repealing them, and second a PDC induced in the solenoid coils 147 & 149 which feeds, because of the parallel connection, each electric motor-generator solenoid coil 148, thereby forming a temporary active closed energetic circuit for each section of the linear ferromagnetic column.

Having now established the means for levitation, the guidance with its control and the necessary electric energy in the, electric motor-generator solenoid coils 148, we have just to activate each electro magnet or solenoid 147 & the energy collector & inductor 170 from the stator's assembly 142 with DC energy in order to obtain the necessary thrust force and the desired direction of movement of the load, as an effect of UMP interactions between the two different magnetic sources, i.e., the electric motor effect.

It is noted that using the entire moving portions inertia, we can recover the energy spent in accelerating it to an operating speed, transforming the kinetic potential energy into electromagnetic energy, while providing an efficient braking system.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A DC linear electric motor-generator has located at each edge of a curved triangular shaped linear ferromagnetic core, electro-magnets or solenoids interconnected in series or parallel as determined by user objectives, with each main solenoid coil hosted by each segment of the ferromagnetic core.
